(19) United States
(12) Patent Application Publication
(10) Pub. No.: US 2013/0295923 A1
(43) Pub. Date: Nov. 7, 2013

(54) METHOD FOR PROVIDING INFORMATION TO A SUBSCRIBER OF A MOBILE COMMUNICATION NETWORK

(71) Applicants: Erkki Joensuu, Siuntio (FI); Timo Ala-Rämi, Nummela (FI)

(72) Inventors: Erkki Joensuu, Siuntio (FI); Timo Ala-Rämi, Nummela (FI)

(73) Assignee: Telefonaktiebolaget L M Ericsson, Stockholm (SE)

(21) Appl. No.: 13/990,297

(22) PCT Filed: Dec. 3, 2010
(86) PCT No.: PCT/EP2010/068833

§ 371 Date: Jun. 13, 2013

(51) Int. Cl. H04W 4/12

(52) U.S. Cl. CPC H04W 4/12
USPC 455/432.1; 455/466

(57) ABSTRACT

The invention relates to a method for providing information to a subscriber (14; 25; 35) of a mobile communication network, said method comprising the steps of receiving a call setup message (110; 210; 314) which is used to set up a call between the originator associated to the call setup message (110; 210; 314) and the subscriber (14; 25; 35), detecting (111; 213; 315) an indicator in the call setup message which indicates the sending of a message to the subscriber (14; 25; 35), releasing the call (112; 215; 316) towards the originator and sending (114; 217; 318) a message to the subscriber.

### TECHNICAL FIELD

The invention relates to a method for providing information to a subscriber of a mobile communication network. Further the invention relates to a node adapted to perform a method for providing information to a subscriber of a mobile communication network.

### BACKGROUND

In communication networks in countries, where the legislation forbids charging of unanswered calls, these calls are used to pass information to a called subscriber without generating a chargeable connection between a caller and a called subscriber. Both communication parties predefined which information is linked to a specific number of ringing tones or consecutive call attempts. It is e.g. possible that one ringing tone or call attempt means “call me back” or two ringing tones or call attempts means “come home”. Therefore the caller has e.g. to count the ringing tones after he set up a call to the called subscriber or he has to count the number of call attempts. When the number of ringing tones or call attempts reaches a predefined or specific number of rings which is linked to specific information, the caller releases the call. The called subscriber did not pick up the phone to prevent the establishment of a chargeable connection.

Every unanswered call generates traffic load on the control plane and the user plane of the net of a provider of a telecommunication network.

One solution of a cost effective transport of information is the use of a Short Message Service (SMS). This service is defined in the 3^{rd} Generation Partnership Project 2 standard 3GPP2 C.S0015-0 and allows the transmission of 160 characters in one SMS message. Sending a SMS message generates costs for the originator even if these costs are sometimes included in a flatrate. Sending of SMS messages is not possible if the caller uses a phone or mobile phone without any display. Coin boxes and most wireline phones do not contain means for showing or generating the content of a SMS message.

### SUMMARY

It is an object of the present invention to improve the sending of information messages to a subscriber of a mobile communication network. This object is achieved by the independent claims. Advantageous embodiments are described in the dependent claims.

In an embodiment of the invention, a method for providing information to a subscriber of a mobile communication network is proposed, comprising the step of receiving a call setup message which is used to set up a call between the originator associated to the call setup message and the subscriber. The method further comprises the step of detecting an indicator in the call setup message which indicates the sending of a message to the subscriber. The method further comprises the step of releasing the call towards the originator and sending a message to the subscriber. The call setup message is initiated by an originator of the call in the originating network. This call setup message might be of different format in accordance with the current network type. This network could be a wireline (PSTN=public switched telephone network) or any other kind of mobile network. In this embodiment, the call between both parties is not established because after an indicator is detected, the call is released. Releasing the call means that resources which are allocated to this call will be deleted or released and can be used for other purposes or calls. In the switching node which detected the indicator, the resources for this call must be reserved until the message to the subscriber is sent. This message can be sent to a message system, such as a Short message Service (SMS) system, which can create and forward a SMS message to the subscriber. It is also possible to have another message system instead of the SMS system to create and forward a message to the subscriber. The message can be any kind of information element, such as a SMS or MMS (Multimedia message system) message.

In a further embodiment said method comprises the further step of determining an identifier in the call setup message which is indicative of one message out of a plurality of messages and sending the message to the subscriber in dependence on the identifier. It is therefore possible to differentiate between pluralities of contents in a message. It is possible that the identifier and the indicator are of the same value. The message which is sent to the subscriber may comprise the identifier of the call setup message. It is also possible that the message comprises a corresponding text which is linked with the identifier. That means that every identifier (e.g. 1, 2, etc . . . ) is linked with a corresponding text like:

1 “Please come home”

2 “Call me back”

The identifier and the corresponding specific text may be stored in a database. The database could be located in a node of the mobile communication network. The text message could further comprise the number of the originator to allow the subscriber to identify the originator of the message.

In a further embodiment the call setup message is an Initial Address Message, IAM. It is also possible that the indicator is a routing number prefix.

In another embodiment of the invention the identifier is a suffix value of the call setup message.

In a further embodiment of the invention the originator of the call setup message receives a release-indication when the call is released. The release-indication can be a tone indication.

In a further embodiment of the invention, a roaming number query is conducted to determine the address of the subscriber after the call is released.

The invention further comprises a switching node of a circuit-switched network, comprising a receiving unit, adapted to receive a call setup message which is used to set up a call between the originator associated to the call setup message and the subscriber, a first processing unit, adapted to detect an indicator in the call setup message which indicates the sending of a message to the subscriber, a communication unit, adapted to release the call towards the originator and a sending unit, adapted to send a message to the subscriber.

In a further embodiment of the invention the switching node comprises a second processing unit, adapted to determine an identifier in the call setup message which is indicative of one message out of a plurality of messages, and wherein the sending unit is adapted to send the message to the subscriber in dependence on the identifier.

The inventive switching node may be adapted to perform all the steps of the prescribed method of at least one of the other embodiments.

The present invention also concerns computer programs comprising portions of software codes in order to implement the method as described above when operated by a respective processing unit of a user device and a recipient device. The computer program can be stored on a computer-readable medium. The computer-readable medium can be a permanent or rewritable memory within the user device or the recipient device or located externally. The respective computer program can also be transferred to the user device or recipient device for example via a cable or a wireless link as a sequence of signals.

In the following, detailed embodiments of the present invention shall be described in order to give the skilled person a full and complete understanding. However, these embodiments are illustrative and not intended to be limiting.

### BRIEF DESCRIPTION OF THE FIGURES

FIG. 1 shows an exemplary sequence diagram of a first embodiment of the invention,

FIG. 2 shows an alternative exemplary sequence diagram of a second embodiment of the invention,

FIG. 3 shows a further alternative exemplary sequence diagram of a third embodiment of the invention,

FIG. 4 shows a schematic block diagram of a switching node, illustrating functional units of the switching node being connected to other network nodes according to an embodiment of the invention.

### DETAILED DESCRIPTION

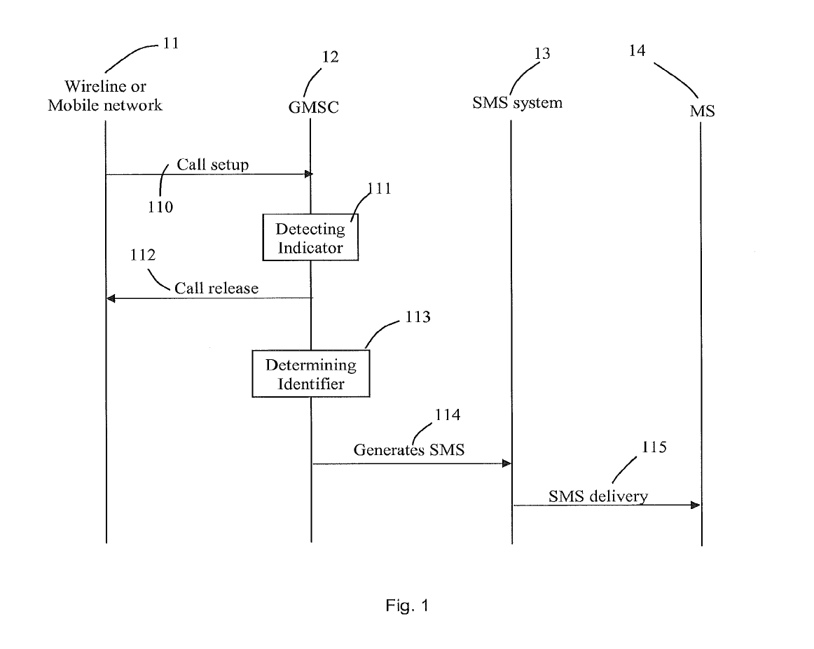

FIG. 1 shows a first embodiment of the invention and depicts a sequence diagram which comprises a wireline or mobile network 11 and a mobile network. The mobile network comprises a gateway mobile switching center (GMSC) 12, a short message service (SMS) system 13 and a mobile subscriber (MS) 14. The wireline or mobile network 11 can be any type of network, such as a public switched telephone network or any kind of circuit switched mobile or packet switched mobile network. A GMSC can be any type of gateway node of a mobile network such as GSGSN in a packet switched environment. A SMS system 13 can be any type of message system in a mobile network which is adapted to create and send messages to a subscriber.

A subscriber of this wireline or mobile network 11, who is not depicted in FIG. 1, wants to send a message to the MS 14. The subscriber of the wireline or mobile network 11 might use a telephone system which is not able to send or receive SMS-messages. An example of such a telephone system is a coin-operated telephone or a coin-box telephone.

In a first step 110, a node in the wireline or mobile network 11 of the originator sends a call setup message to the GMSC of the network in which the receiver of the call (MS) 14 is located. This call setup can be an initial address message (IAM) using the bearer independent call control protocol (BICC) or the ISDN user part protocol (ISUP). The call setup message comprises, among others, the called party number and several routing data. According to the invention and the first embodiment, the call setup message comprises an additional prefix or suffix which was added to the called party number by the originator. An example for a suffix is #3 which is added to a called party number. An example is 12345#3 wherein 12345 is the called party number and #3 is the suffix. In a further embodiment, the suffix or prefix is divided into an indicator and an identifier. The indicator indicates the special handling of this call in accordance with the invention which is described further below. The identifier can be used to identify the content of information sent to the called MS. Therefore, the suffix or prefix can consist of two different information elements e.g. numbers. An example is the called number “12345#13” wherein “12345” is the called party number and “#13” is the suffix, consisting of an indicator “1” and an identifier “3”. The symbol “#” is used to separate between the called party number and the suffix. It is possible to use other symbols, such as “*”. It is also possible to combine the called party number with a prefix to indicate the sending of a message to the MS 14. Reason to change the separator could be that if the called subscriber uses the received calling party number for a return call “as is”, the call would be ineffective because some of the separators are used in a different way. An example for a prefix number is “0888” which can be a routing number prefix. The using of this routing number prefix is to avoid impacts in other operator network infrastructure, especially in countries where number portability according to the standard 3GPP 23.066 or according to other national standards is used. The purpose of this prefix number is to bypass all number portability impacts and related costs.

In a second step 111 of the first embodiment of this invention, the control node 12 detects an indicator in the call setup message. If an indicator is detected, the control node 12 deals this call in a specified manner.

In a third step 112, the control node 12 releases the call leg to the originator of the call if an indicator was detected in the second step 111. No resources for the user plane will be seized.

After the identifier in the call setup message is determined 113, the control node 12 generates a SMS 115 to the called party 14 and sends it to the SMS system 13. The content of the text message is a text or symbol corresponding to the value of the identifier. The SMS system delivers 115 the SMS to the MS 14. The SMS system 13 is an example and can be any kind of message transportation system which is implemented in a communication network. To find the logical interconnection between the identifier and the content of the text message, the control node 12 can retrieve data from a database in the network. This database can be located in the control node 12 or in any other network node of the communication system. It is possible that the SMS system 13 comprises this database.

In another embodiment of the invention, the control node 12 might send a message including the number of the called subscriber 14 and the identifier to the SMS system 13. The SMS system 13 generates a text message based on the received identifier and sends it to the MS 14 by using the number of the called subscriber 14. In another embodiment of the invention, the called subscriber will receive additionally the number of the originator of this call.

In another embodiment of the invention, the originator receives an indicator that the information is transferred to the MS 14. This indicator can be a tone-indication to make sure that the originator is informed even if the originator does not have a display or other indication means available.

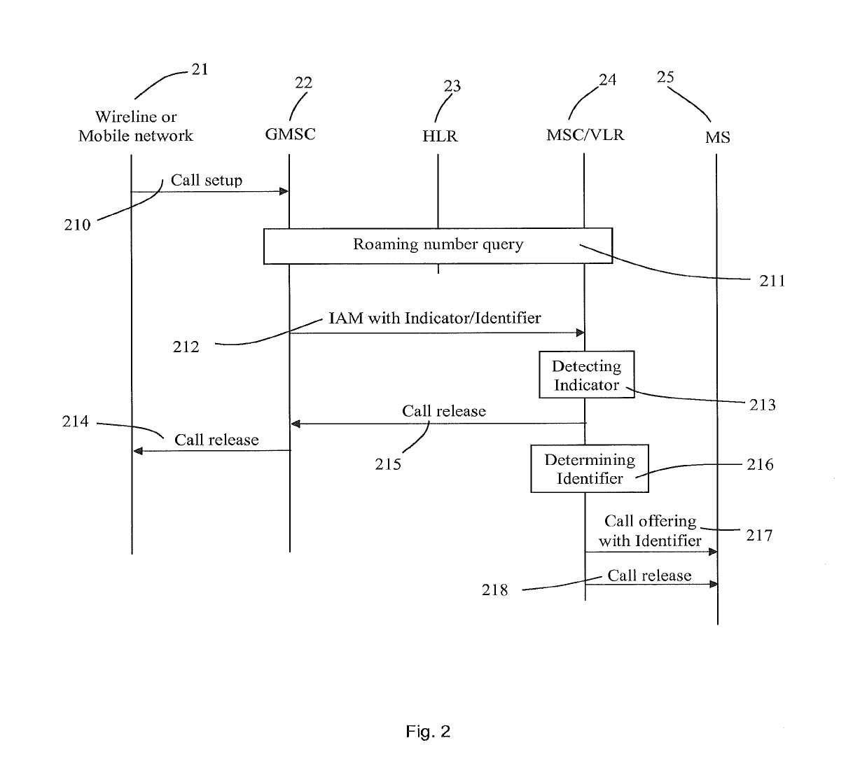

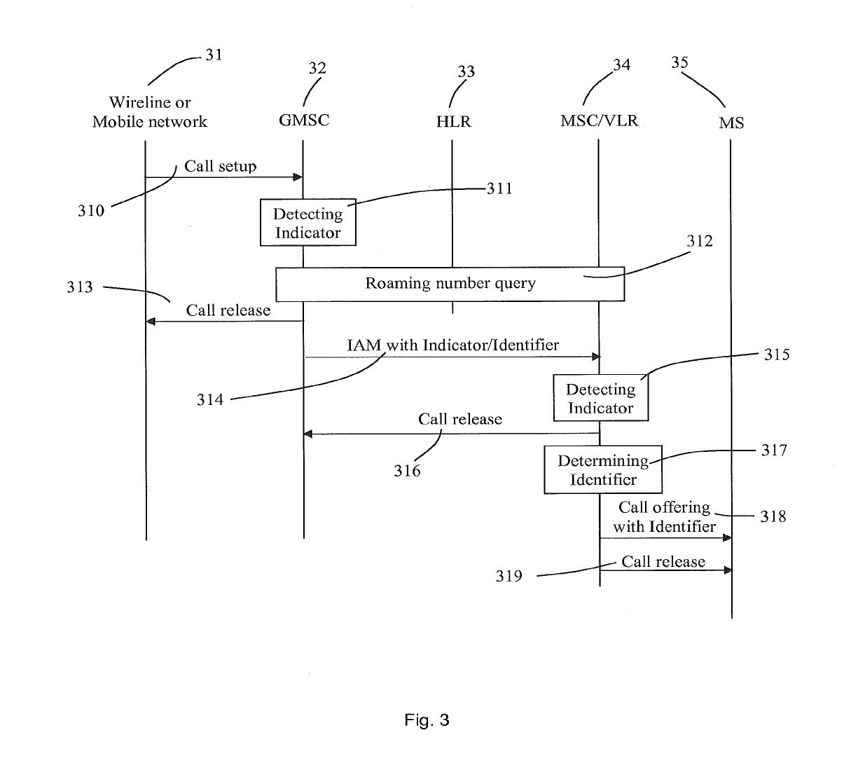

FIGS. 2 and 3 show a second embodiment of the invention. The first step 210 is comparable to the first step 110 of the first embodiment, wherein the originator sends a call setup message to the GMSC 22 of the network in which the MS 14 is located. In a second step 211 the GMSC 22 starts a normal data base enquiry to the number portability database and a roaming number enquiry to the HLR 23 in accordance with standardized procedures. The number portability database is not shown in FIGS. 2 and 3 to reduce the complexity of the figures. The GMSC only uses the mobile subscriber integrated services digital network number (MSISDN number) without any suffix or prefix number to avoid an impact to the number portability database, the HLR 23 or the VLR of the MSC 24.

After the roaming procedure, the GMSC 22 knows the MSC 24 at which the MS 25 is linked at this moment. The GMSC 22 then starts the normal call setup procedure 212 including the mobile station routing number (MSRN), plus the extra suffix or prefix. No resource for the user plane is seized (e.g. in the media gateways). The normal call setup procedure 212 can also include the number of the originator if this number should be displayed at the device of the MS 25.

In a next step 213, the MSC/VLR 24 detects the indicator in the call setup message 212 which could be an IAM message. After the indicator is detected 213, the MSC/VLR releases the call leg 215 with the GMSC 22. The GMSC 22 then releases the call leg 214 to the wireline or mobile network 21. The resources needed for this call can now be used to establish other calls.

In a next step 216, the MSC 24 determines the identifier in the call setup message follows by a call offering message 217 to MS 25 including this identifier. The identifier could be modified by the MSC 24 to prevent failures due to different interpretation of prefixes or suffixes. By passing this information in the call offering, e.g. inside the calling party number, guaranties that all different type of phone devices are able to display this information during the phone is ringing. After the call is offered to the MS 25, the call is released by the MSC in the next step 218. If the real calling party number is not available or prohibited to be shown because e.g. the call was initiated via a coin telephone box, just the additional prefixes or suffixes will be shown on the display of the MS 25.

It is possible that the MS 25 comprises means for a further processing of the received prefix or suffix. It might be possible that the MS 25 comprises a database which translates the prefix or suffix into a clear text message.

The difference between the second embodiment, depicted in FIG. 2 and the third embodiment, depicted in FIG. 3, is the call release 313 of the call leg between the GMSC 32 and the wireline or mobile network 31 of the originator of the call. The call release 313 is performed after the GMSC detects 311 the indicator in the call setup message 310. The advantage of an early release of the call leg between the GMSC 32 and the wireline or mobile network 31 of the originator of the call is that the resources have been de-allocated for other call establishments.

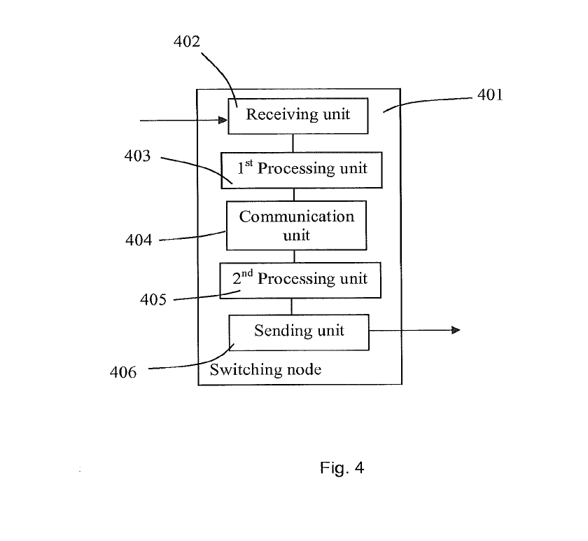

FIG. 4 depicts a switching node 401 of a circuit-switched network. The switching node can be a mobile switching center (MSC) or Gateway MSC (GMSC) in a circuit switched network, a Serving or Gateway GPRS Support Node in a packet switched network or any other node which is adapted to process call control messages like call setup messages. The switching node comprises a receiving unit 402, adapted to receive a call setup message which is used to set up a call between the originator associated to the call setup message and the subscriber, a first processing unit 403, adapted to detect an indicator in the call setup message which indicates the sending of a message to the subscriber, a communication unit 404, adapted to release the call towards the originator and a sending unit 406, adapted to send a message to the subscriber. Further the switching node 401 comprises a second processing unit 405, adapted to determine an identifier in the call setup message which is indicative of one message out of a plurality of messages, and wherein the sending unit 406 is adapted to send the message to the subscriber in dependence on the identifier.

1. A method for providing information to a subscriber of a mobile communication network, said method comprising the steps of:
receiving a call setup message which is used to set up a call between the originator associated to the call setup message and the subscriber,
detecting an indicator in the call setup message which indicates the sending of a message to the subscriber,
releasing the call towards the originator
sending a message to the subscriber.

2. Method according to claim 1, wherein detecting the indicator in the call setup message comprises the further step of determining an identifier in the call setup message which is indicative of one message out of a plurality of messages and sending the one message out of the plurality of messages to the subscriber in dependence on the identifier.

3. Method according to claim 1, wherein the message comprises the indicator in the call setup message.

4. Method according to claim 2, wherein the one message out of the plurality of messages comprises a corresponding text which is linked with the identifier.

5. Method according to claim 4, wherein the identifier and the corresponding text are stored in a database.

6. Method according to claim 5, wherein the database is located in a node of the mobile communication network.

7. Method according to claim 4, wherein the text message further comprises the number of the originator.

8. Method according to claim 1, wherein the call setup message is an Initial Address Message, IAM.

9. Method according to claim 1, wherein the indicator is a routing number prefix.

10. Method according to claim 2, wherein the identifier is a suffix value of the call setup message.

11. Method according to claim 1, wherein the originator of the call setup message receives a release-indication when the call is released.

12. Method according to claim 11, wherein the release-indication is a tone indication.

13. Method according to claim 1, wherein after the call is released, a roaming number query is conducted to determine the address of the subscriber.

14. A switching node of a circuit-switched network, comprising:
a receiving unit, adapted to receive a call setup message which is used to set up a call between the originator associated to the call setup message and the subscriber,
a first processing unit, adapted to detect an indicator in the call setup message which indicates the sending of a message to the subscriber,
a communication unit, adapted to release the call towards the originator,
a sending unit, adapted to send a message to the subscriber.

15. The switching node according to claim 14, wherein the switching node further comprises a second processing unit, adapted to determine an identifier in the call setup message which is indicative of one message out of a plurality of messages, and wherein the sending unit is adapted to send the one message out of the plurality of messages to the subscriber in dependence on the identifier.

16. The switching node according to claim 14, adapted to perform all the steps of the method of claim 14.
